(19) United States
(12) Patent Application Publication
(10) Pub. No.: US 2017/0019700 A1
(43) Pub. Date: Jan. 19, 2017

(54) MOBILE REAL-TIME VIDEO RECORDING AND TRANSMISSION MIRROR/HAIRBRUSH/LIPSTICK

(71) Applicant: CHIEN-TU TSENG, TAIPEI CITY (TW)

(72) Inventor: CHIEN-TU TSENG, TAIPEI CITY (TW)

(21) Appl. No.: 14/797,328

(22) Filed: Jul. 13, 2015

(51) Int. Cl. H04N 21/4223; H04N 5/77; H04N 5/91; H04N 21/437; H04N 21/41; H04N 21/4363; H04N 5/225; H04N 21/2743

(52) U.S. Cl. CPC H04N 21/4223; H04N 5/2253; H04N 5/77; H04N 5/2256; H04N 21/2743; H04N 21/437; H04N 21/4126; H04N 21/43637; H04N 5/91

(57) ABSTRACT

A mobile real-time video recording and transmission mirror/hairbrush/lipstick includes a mirror holder holding a webcam, a processing circuit assembly consisting of an image processing circuit and a wireless transmission circuit, a battery, a USB charging jack for the connection of a USB charging cable to charge the battery with an external power source, white LEDs for lighting enhancement, infrared LEDs for giving off infrared light when space appears dark or at night, and a control switch for switching on/off the webcam.

### BACKGROUND OF THE INVENTION

1. Field of the Invention

The present invention relates to real-time video recording and transmission technology and more particularly, to a mobile real-time video recording and transmission mirror/hairbrush/lipstick having a real-time video recording and transmission module therein for picking up images of any part of the face, the head or the body of the user that the user cannot directly see through the traditional mirror and then transmitting the video signals thus obtained to the user's smart phone or tablet computer for display on the screen of the smart phone or tablet computer.

2. Description of the Related Art

Women usually will carry a mobile mirror so that they can watch the face or the hair in the mirror when making up the eyes or the face or when styling and dressing the hair. However, when making up the face or when styling and dressing the hair, one may be unable to directly watch certain part of the face or the hair in the mirror. It is therefore desirable to find a measure that solves the above problem.

### SUMMARY OF THE INVENTION

The present invention has been accomplished under the circumstances in view. It is one object of the present invention to provide a mobile real-time video recording and transmission mirror/hairbrush/lipstick, which allows the user to pick up the images of any part of the face, the head or the body of the user that the user cannot directly watch in the mirror.

To achieve this and other objects of the invention, a mobile real-time video recording and transmission mirror/hairbrush/lipstick comprises a mirror holder, a mirror mounted within said mirror holder, a webcam mounted in the mirror holder, a processing circuit assembly mounted in the mirror holder at a rear side relative to the mirror and comprising an image processing circuit for processing images picked up by the webcam into corresponding digital video signals and a wireless transmission circuit for transmitting the digital video signals thus obtained to an external smart phone or tablet computer for enabling the image signals to be displayed on the screen of the smart phone or tablet computer subject to the running of an APP in the smart phone or tablet computer, a battery mounted in the mirror holder and electrically connected to the processing circuit assembly for providing the processing circuit assembly with the necessary working electricity, a USB charging jack located at a bottom side of the mirror holder for the connection of a USB charging cable to charge the battery, and a control switch mounted in a peripheral wall of the mirror holder and operable to switch on/off said webcam.

### BRIEF DESCRIPTION OF THE DRAWINGS

FIG. 1 is a schematic perspective view of a mobile real-time video recording and transmission mirror in accordance with a first embodiment of the present invention.

FIG. 2 illustrates the relationship between the mobile real-time video recording and transmission mirror and a USB charging cable in accordance with the first embodiment of the present invention.

FIG. 3 corresponds to FIG. 1, illustrating control switches mounted in the peripheral wall of the mirror holder.

FIG. 4 is an enlarged view of a part of FIG. 3, illustrating the arrangement of one control switch on the peripheral wall of the mirror holder.

FIG. 5 is a schematic applied view of the mobile real-time video recording and transmission mirror in accordance with the first embodiment of the present invention.

FIG. 6 illustrates a mobile real-time video recording and transmission mirror in a flip up design in accordance with a second embodiment of the present invention.

FIG. 7 illustrates a mobile real-time video recording and transmission mirror in a hairbrush design in accordance with a third embodiment of the present invention.

FIG. 8 illustrates a mobile real-time video recording and transmission mirror in a lipstick design in accordance with a fourth embodiment of the present invention.

FIG. 9 illustrates a mobile real-time video recording and transmission mirror in an eyebrow pencil/blush brush design in accordance with a fifth embodiment of the present invention.

### DETAILED DESCRIPTION OF THE PREFERRED EMBODIMENT

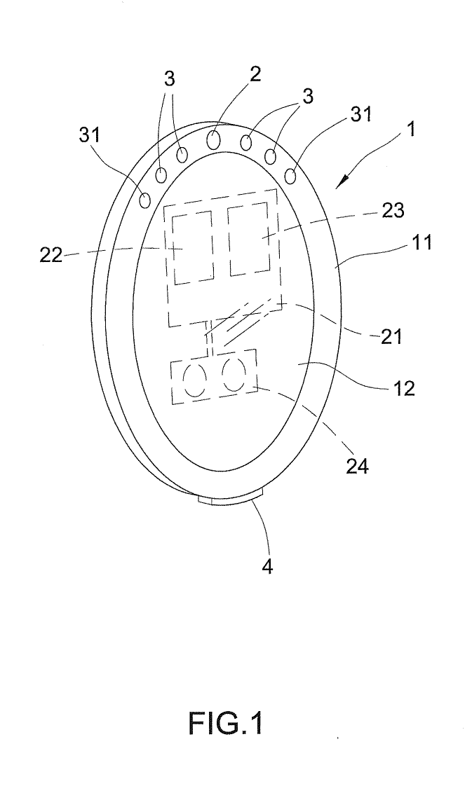

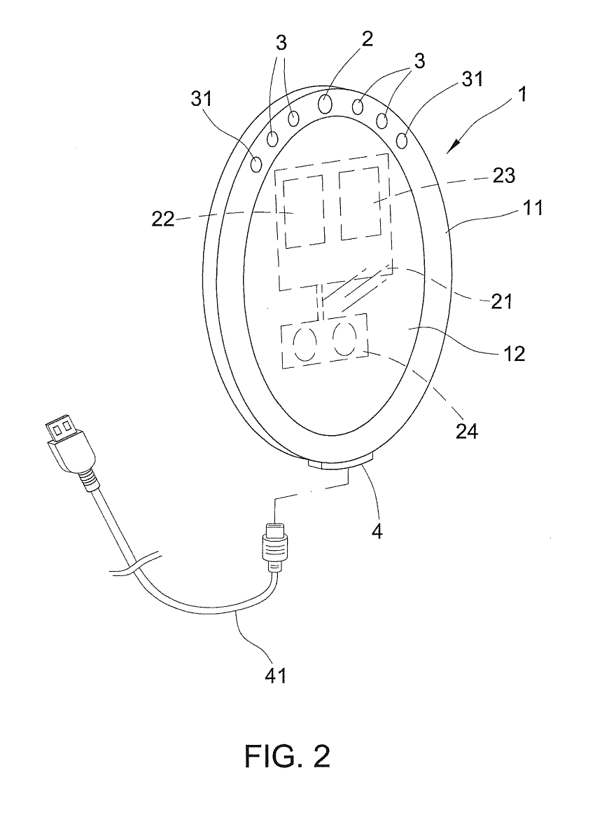

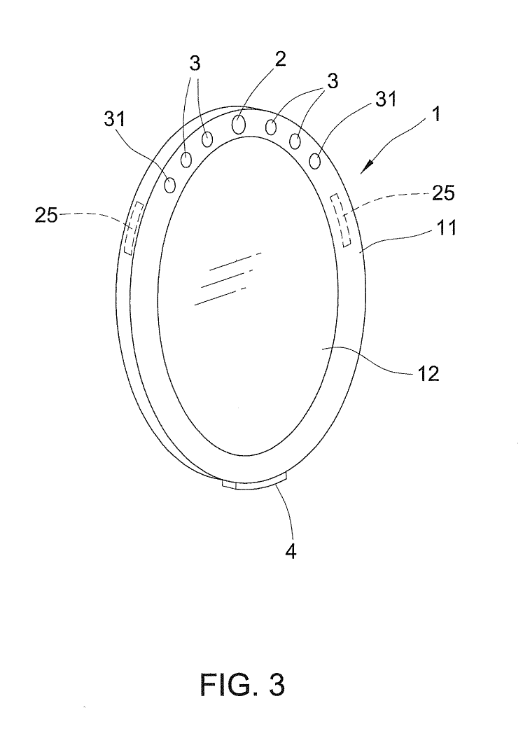

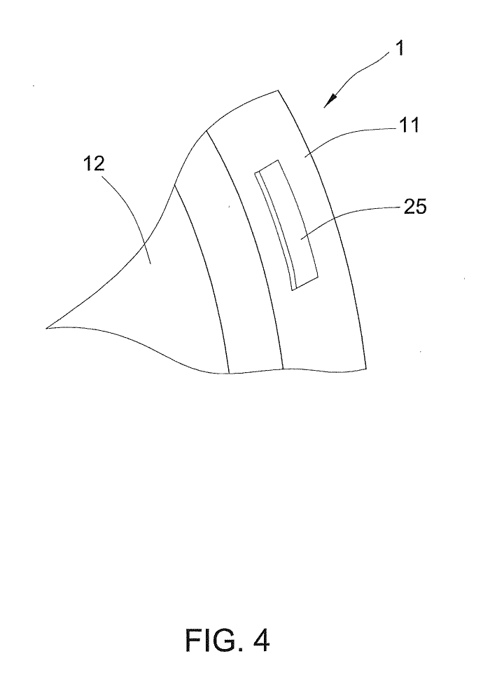

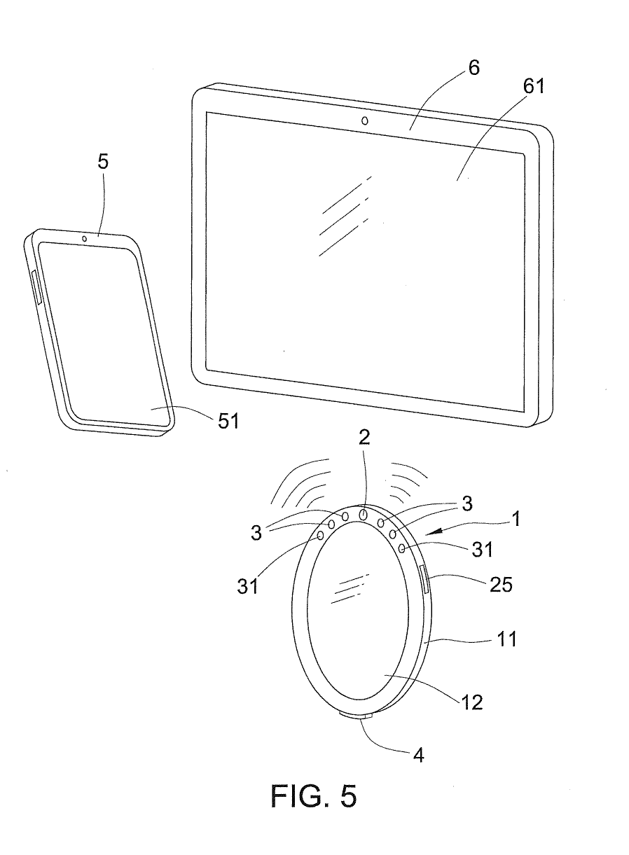

Referring to FIGS. 1-4, a mobile real-time video recording and transmission mirror/hairbrush/lipstick (1) in accordance with a first embodiment of the present invention is shown. The mobile real-time video recording and transmission mirror (1) comprises a mirror holder (11), a mirror (12) mounted in a front side within the mirror holder (11), a webcam (2) mounted in a front side in the mirror holder (11) at a selected location, a processing circuit assembly (21) mounted in the mirror holder (11) at a rear side relative to the mirror (12) and comprising an image processing circuit (22) and a wireless transmission circuit (23) that can be, for example, Wi-Fi or Bluetooth or ZigBee, a battery (24) mounted in the mirror holder (11) and electrically connected to the processing circuit assembly (21) for providing the processing circuit assembly (21) with the necessary working electricity, a USB charging jack (4) located in a bottom side of the mirror holder (11) and electrically coupled with the battery (24) for the connection of a USB charging cable (41) to charge the battery (24) with an external power source or in a wireless charging manner, a plurality of white LEDs (31) mounted in the mirror holder (11) around the mirror (12) and adapted for lighting enhancement, a plurality of infrared LEDs (3) mounted in the mirror holder (11) around the mirror (12) and adapted for giving off infrared light when space appears dark or at night, and control switches (25) mounted at the peripheral wall of the mirror holder (11) and operable to switch on or off the webcam (2). In application, the user can use the webcam (2) of the mobile real-time video recording and transmission mirror (1) to pick up the images continuously of any part of the head or the body that the user cannot directly watch in the mirror (12), enabling the images to be processed through the image processing circuit (22) and then transmitted by the wireless transmission circuit (23) wirelessly to the user's smart phone (5) or tablet computer (6). Through the operation of a built-in APP of the smart phone (5) or tablet computer (6), the images picked up by the webcam (2) can then be real-time displayed on the screen (51) or (61) of the user's smart phone (5) or tablet computer (6) (see FIG. 5). Further, the webcam (2) and the processing circuit assembly (21) and the wireless transmission circuit (23) can be integrated into a real-time video recording and transmission module.

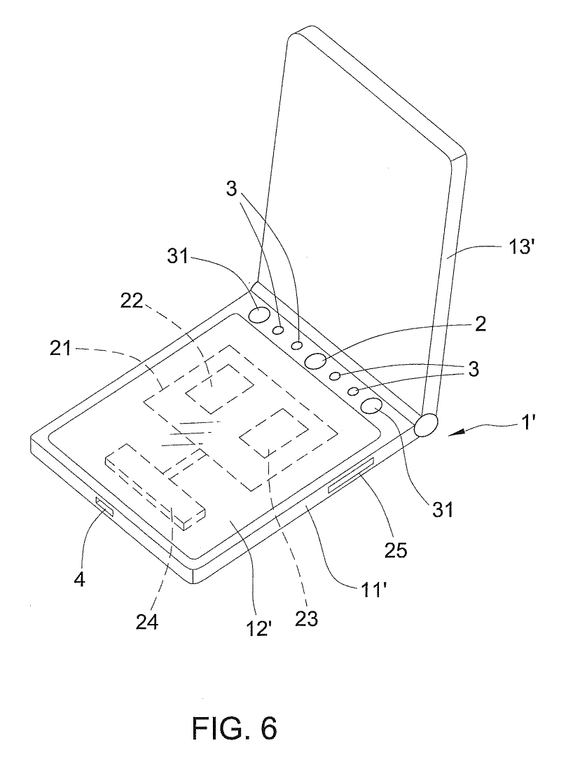

FIG. 6 illustrates a mobile real-time video recording and transmission mirror/hairbrush/lipstick (1′) in accordance with a second embodiment of the present invention. According to this second embodiment, the mobile real-time video recording and transmission mirror/hairbrush/lipstick (1′) comprises a flat rectangular mirror holder (11′), a mirror (12′) mounted in a front side within the mirror holder (11′), mirror cover (13′) hinged to one peripheral edge of the mirror holder (11′) and closable on the mirror (12′), a webcam (2) mounted in a front side in the mirror holder (11′), at a selected location, a processing circuit assembly (21) mounted in the mirror holder (11′) at a rear side relative to the mirror (12′) and comprising an image processing circuit (22) and a wireless transmission circuit (23) that can be, for example, Wi-Fi or Bluetooth or ZigBee, a battery (24) mounted in the mirror holder (11) and electrically connected to the processing circuit assembly (21) for providing the processing circuit assembly (21) with the necessary working electricity, a USB charging jack (4) located in a bottom side of the mirror holder (11′) and electrically coupled with the battery (24) for the connection of a USB charging cable (41) to charge the battery (24) with an external power source or in a wireless charging manner, a plurality of white LEDs (31) mounted in the mirror holder (11′) around the mirror (12′) and adapted for lighting enhancement, a plurality of infrared LEDs (3) mounted in the mirror holder (11′) around the mirror (12′) and adapted for giving off infrared light when space appears dark or at night, and control switches (25) mounted at the peripheral wall of the mirror holder (11′) and operable to switch on or off the webcam (2).

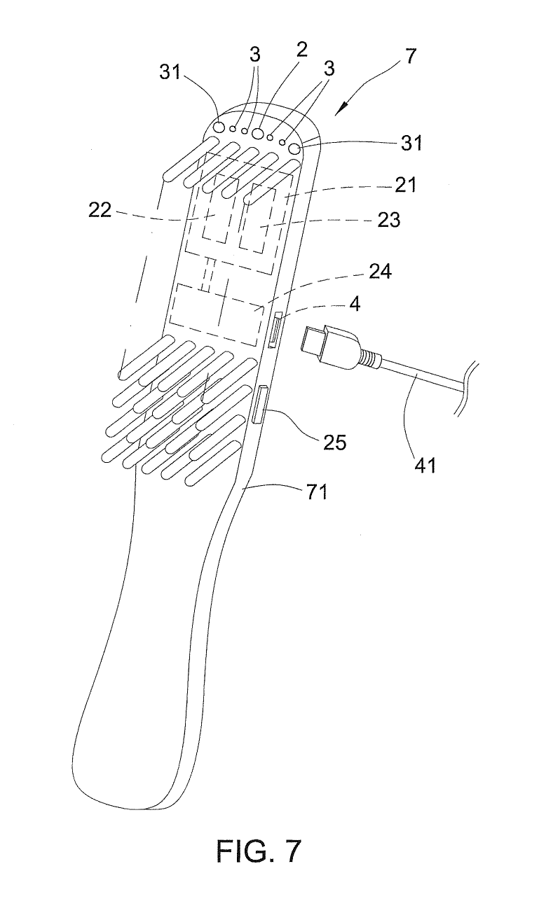

FIG. 7 illustrates a mobile real-time video recording and transmission mirror/hairbrush/lipstick (7) in a hairbrush design in accordance with a third embodiment of the present invention. The mobile real-time video recording and transmission mirror/hairbrush/lipstick (7) comprises a mirror holder in the form of a hairbrush body (71), a webcam (2) mounted in a front side in the hairbrush body (71) at a selected location, a processing circuit assembly (21) mounted in the hairbrush body (71) and comprising an image processing circuit (22) and a wireless transmission circuit (23) that can be, for example, Wi-Fi or Bluetooth or ZigBee, a battery (24) mounted in the hairbrush body (71) and electrically connected to the processing circuit assembly (21) for providing the processing circuit assembly (21) with the necessary working electricity, a USB charging jack (4) located in one lateral side of the hairbrush body (71) and electrically coupled with the battery (24) for the connection of a USB charging cable (41) to charge the battery (24) with an external power source or in a wireless charging manner, a plurality of white LEDs (31) mounted in the hairbrush body (71) and adapted for lighting enhancement, a plurality of infrared LEDs (3) mounted in the hairbrush body (71) and adapted for giving off infrared light when space appears dark or at night, and control switches (25) mounted at the peripheral wall of the hairbrush body (71) and operable to switch on or off the webcam (2).

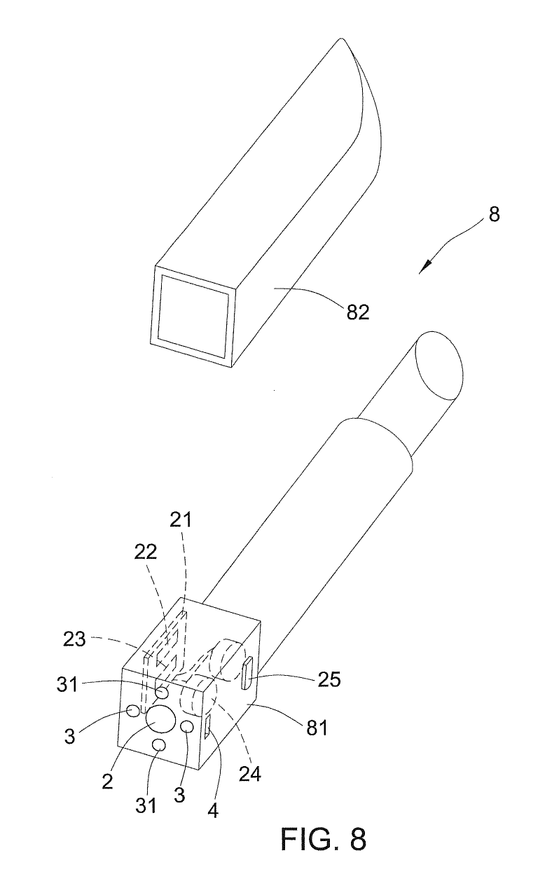

FIG. 8 illustrates a mobile real-time video recording and transmission mirror/hairbrush/lipstick (8) in a lipstick design in accordance with a fourth embodiment of the present invention. The mobile real-time video recording and transmission mirror/hairbrush/lipstick (8) comprises a mirror holder in the form of a lipstick body (81), a lipstick cap (82) for protecting the lipstick body (81), a webcam (2) mounted in a front side in the lipstick body (81) at a selected location, a processing circuit assembly (21) mounted in the lipstick body (81) and comprising an image processing circuit (22) and a wireless transmission circuit (23) that can be, for example, Wi-Fi or Bluetooth or ZigBee, a battery (24) mounted in the lipstick body (81) and electrically connected to the processing circuit assembly (21) for providing the processing circuit assembly (21) with the necessary working electricity, a USB charging jack (4) located in one lateral side of the lipstick body (81) and electrically coupled with the battery (24) for the connection of a USB charging cable (41) to charge the battery (24) with an external power source or in a wireless charging manner, a plurality of white LEDs (31) mounted in the lipstick body (81) and adapted for lighting enhancement, a plurality of infrared LEDs (3) mounted in the lipstick body (81) and adapted for giving off infrared light when space appears dark or at night, and control switches (25) mounted at the peripheral wall of the lipstick body (81) and operable to switch on or off the webcam (2).

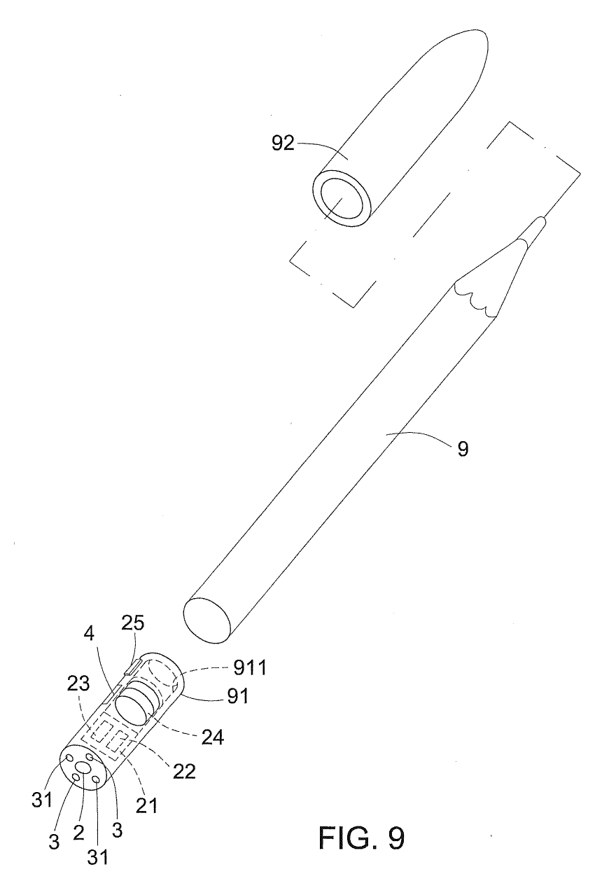

FIG. 9 illustrates a mobile real-time video recording and transmission mirror/hairbrush/lipstick in an eyebrow pencil or blush brush design in accordance with a fifth embodiment of the present invention. According to this fifth embodiment, the mobile real-time video recording and transmission mirror is integrated into an eyebrow pencil/blush brush holder (91) that holds an eyebrow pencil/blush brush (9) in a recessed hole (911) therein and is capped with an eyebrow pencil/blush brush cap (92), comprising a webcam (2), a processing circuit assembly (21) comprising an image processing circuit (22) and a wireless transmission circuit (23) that can be, for example, Wi-Fi or Bluetooth or ZigBee, a battery (24) electrically connected to the processing circuit assembly (21) for providing the processing circuit assembly (21) with the necessary working electricity, a USB charging jack (4) electrically coupled with the battery (24) for the connection of a USB charging cable to charge the battery (24) with an external power source or in a wireless charging manner, a plurality of white LEDs (31) for lighting enhancement, a plurality of infrared LEDs (3) for giving off infrared light when space appears dark or at night, and a control switch (25) operable to switch on or off the webcam (2).

Although particular embodiments of the invention have been described in detail for purposes of illustration, various modifications and enhancements may be made without departing from the spirit and scope of the invention. Accordingly, the invention is not to be limited except as by the appended claims.

What the invention claimed is:

1. A mobile real-time video recording and transmission mirror, comprising:
a mirror holder;
a mirror mounted within said mirror holder;
a webcam mounted in said mirror holder;
a processing circuit assembly mounted in said mirror holder at a rear side relative to said mirror, said processing circuit assembly comprising an image processing circuit adapted for processing images picked up by said webcam into corresponding digital video signals and a wireless transmission circuit adapted for transmitting said digital video signals to an external smart phone or tablet computer for enabling the image signals to be displayed on a screen of the smart phone or tablet computer subject to the running of an APP in the smart phone or tablet computer;
a battery mounted in said mirror holder and electrically connected to said processing circuit assembly for providing said processing circuit assembly with the necessary working electricity;
a USB charging jack located at a bottom side of said mirror holder for the connection of a USB charging cable to charge said battery; and
a control switch mounted in a peripheral wall of said mirror holder and operable to switch on/off said webcam.

2. The mobile real-time video recording and transmission mirror as claimed in claim 1, wherein said wireless transmission circuit is Wi-Fi or Bluetooth or ZigBee.

3. The mobile real-time video recording and transmission mirror as claimed in claim 1, further comprising at least one white LED disposed at one lateral side relative to said webcam and adapted for lighting enhancement.

4. The mobile real-time video recording and transmission mirror as claimed in claim 1, further comprising and at least one infrared LED disposed at an opposite lateral side relative to said webcam and adapted for giving off infrared light when space appears dark or at night.

5. The mobile real-time video recording and transmission mirror as claimed in claim 1, wherein said mirror holder is formed of a part of one of the personal devices of hairbrush, lipstick and eyebrow pencil/blush brush.

6. A mobile real-time video recording and transmission hairbrush, comprising:
a hairbrush body;
a webcam mounted in said hairbrush body;
a processing circuit assembly mounted in said hairbrush body, said processing circuit assembly comprising an image processing circuit adapted for processing images picked up by said webcam into corresponding digital video signals and a wireless transmission circuit adapted for transmitting said digital video signals to an external smart phone or tablet computer for enabling the image signals to be displayed on a screen of the smart phone or tablet computer subject to the running of an APP in the smart phone or tablet computer;
a battery mounted in said hairbrush body and electrically connected to said processing circuit assembly for providing said processing circuit assembly with the necessary working electricity;
a USB charging jack located at a bottom side of said hairbrush body for the connection of a USB charging cable to charge said battery; and
a control switch mounted in a peripheral wall of said hairbrush body and operable to switch on/off said webcam.

7. A mobile real-time video recording and transmission lipstick, comprising:
a lipstick body;
a webcam mounted in said lipstick body;
a processing circuit assembly mounted in said lipstick body, said processing circuit assembly comprising an image processing circuit adapted for processing images picked up by said webcam into corresponding digital video signals and a wireless transmission circuit adapted for transmitting said digital video signals to an external smart phone or tablet computer for enabling the image signals to be displayed on a screen of the smart phone or tablet computer subject to the running of an APP in the smart phone or tablet computer;
a battery mounted in said lipstick body and electrically connected to said processing circuit assembly for providing said processing circuit assembly with the necessary working electricity;
a USB charging jack located at a bottom side of said lipstick body for the connection of a USB charging cable to charge said battery; and
a control switch mounted in a peripheral wall of said lipstick body and operable to switch on/off said webcam.

8. The mobile real-time video recording and transmission lipstick as claimed in claim 7, wherein said lipstick body is formed of a part of one of the personal devices of eyebrow pencil or blush brush.
